(19) United States
(12) Patent Application Publication
(10) Pub. No.: US 2020/0064651 A1
(43) Pub. Date: Feb. 27, 2020

(54) Two-piece Spectacles Frame Fitted with a Fixing Device for a Pair of Lenses

(71) Applicant: New Optic Italia S.R.L., Novi Ligure (IT)

(72) Inventor: Camillo Rattaro, Genoa (IT)

(21) Appl. No.: 16/482,594

(22) PCT Filed: Feb. 19, 2018
(86) PCT No.: PCT/EP2018/000064

§ 371 Date: Jul. 31, 2019

(30) Foreign Application Priority Data
Feb. 22, 2017 (IT) 102017000020206

(51) Int. Cl. G02C 1/08; G02C 1/04

(52) U.S. Cl. CPC G02C 1/08; G02C 1/04; G02C 2200/10; G02C 2200/12; G02C 2200/08

(57) ABSTRACT

A two piece spectacles frame fitted with a fixing device for a pair of lenses to the spectacles frame, the spectacles frame including a rigid upper portion and a lower portion made of deformable material, capable of holding each lens in position by locking, the upper portion including two semi-oval arches, joined by a bridge, each capable of surrounding at least partially each lens, the fixing device including, on the rigid upper portion of the spectacles frame, on each end of the arches, a “C” shaped appendix facing the lenses, wherein the lower end portion of the “C” shaped appendix is fitted with a detent and wherein the ends of the lower portion are fitted with a hole, which permits the locking of the lower portion with the rigid upper portion, once the lenses have been inserted in the special ocular space, by inserting the appendices inside the holes.

This invention relates to a spectacles frame fitted with a fixing device for the lenses in which the upper (ciliary) portion is made of metal or other rigid material, for example carbon fibre, while the lower portion of deformable plastic material.

On the market the so-called “Nylor” type glasses are well known and consist of a two-part frame in which the lenses are joined to the rigid, metallic top portion by a wire, preferably nylon, Kevlar or carbon, which is positioned inside a groove that is cut into the edge of the lens. Said wire thread therefore allows one to join and retain the lens to said upper (ciliary) portion. In particular, the wire is joined and locked to the rigid frame by inserting it into suitable pairs of holes made in the end portions of the rigid frame, generally made of titanium alloy.

Said “Nylor” eyewear of the state of art has some drawbacks since its manufacture is rather complex and expensive due to the need to carry out welding of the metal components and twisting of the internal end portions of the frame itself.

However, it is not easy to remove the lens from the fitting frame—nylon wire thread as it is necessary to exert a certain force by the user on the part so that the various operations turn out to be rather delicate and require a certain skill of the operator.

The subject of this invention is to obviate these drawbacks by providing a spectacles frame fitted with a system for hooking the lenses to the frame itself having the characteristics of the attached claim 1.

The invention will be better explained by the following description, in which the preferred embodiment of the invention is described, made with the aid of the attached Figures which respectively illustrate:

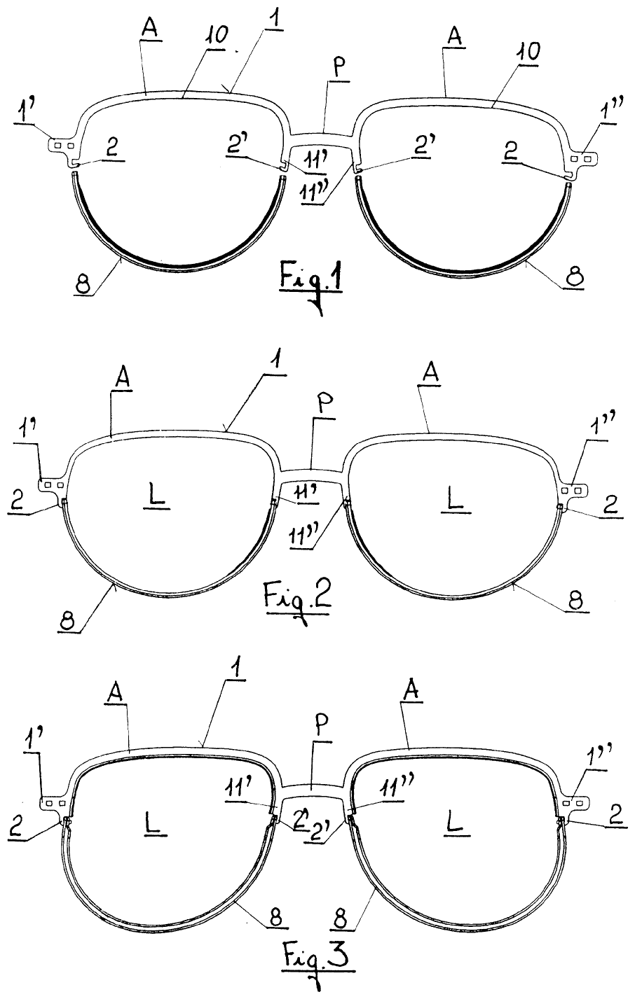

FIG. 1 shows an exploded front view of the frame without lenses according to this invention;

FIG. 2 shows a front view of the frame of FIG. 1 with the lenses mounted;

FIG. 3 shows a front view of a similar frame of that of FIG. 1 having lenses with a slightly different shape from those of FIG. 2;

FIG. 4 shows the upper rigid portion of the frame according to a first embodiment of the invention;

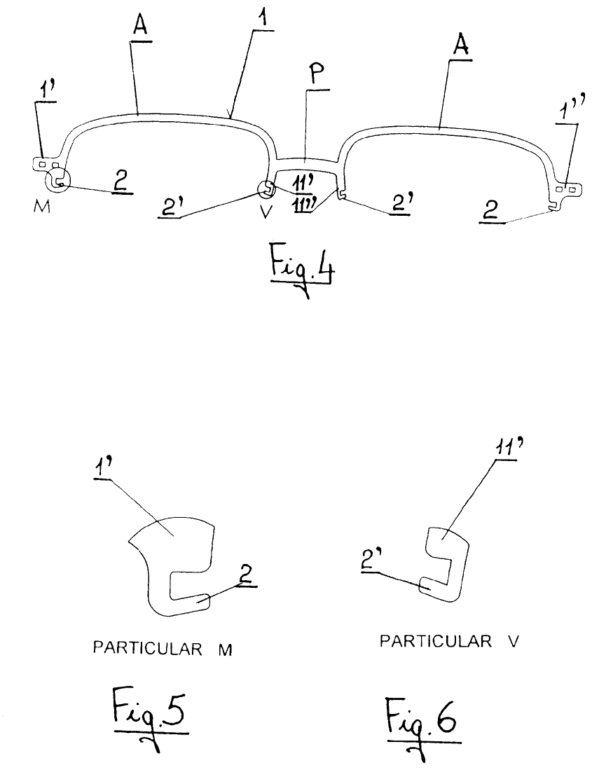

FIG. 5 shows the enlarged detail M of FIG. 4;

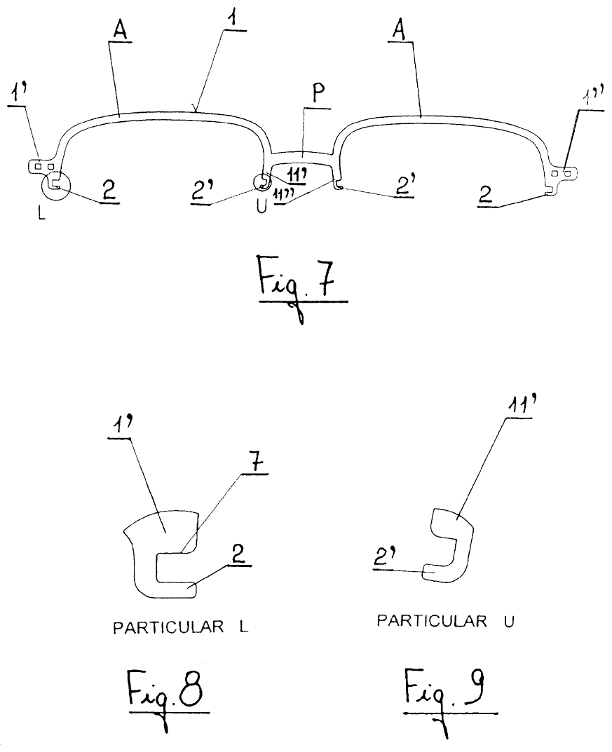

FIG. 6 shows the enlarged detail V of FIG. 4;

FIG. 7 shows the upper rigid portion of the frame according to a second embodiment of the invention;

FIG. 8 shows the enlarged detail L of FIG. 7;

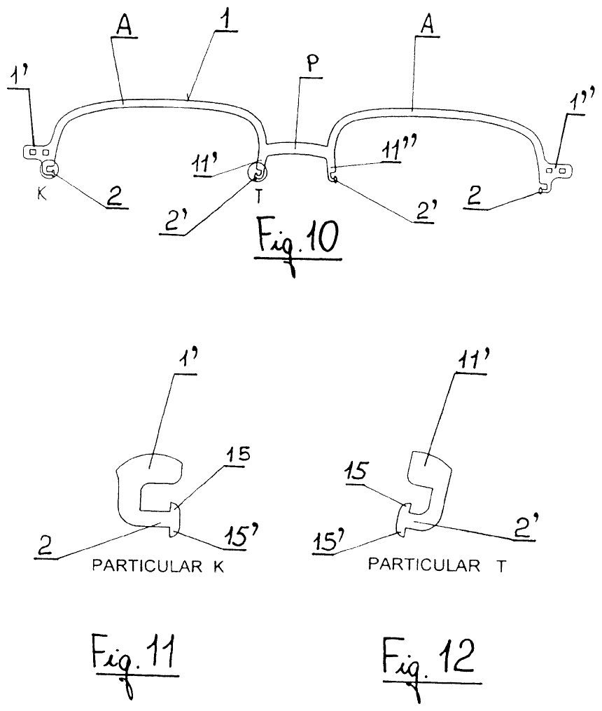

FIG. 9 shows the enlarged detail U of FIG. 7;

FIG. 10 shows the upper rigid portion of the frame according to a third embodiment of the invention;

FIG. 11 shows the enlarged detail K of FIG. 10;

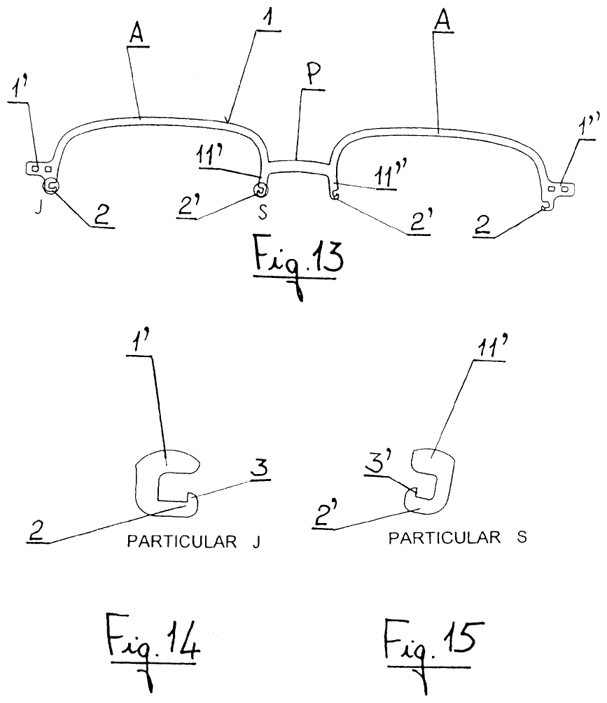

FIG. 12 shows the enlarged detail T of FIG. 10;

FIG. 13 shows the upper rigid portion of the frame according to a fourth embodiment of the invention;

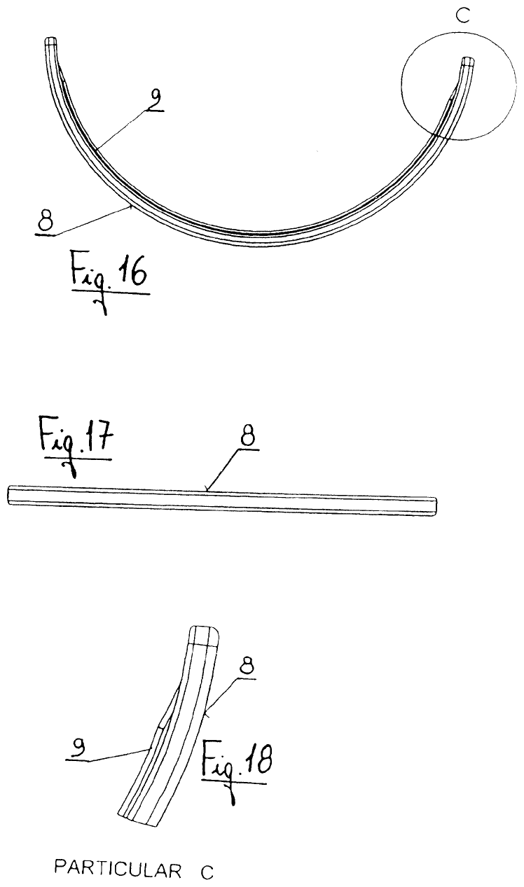

FIG. 14 shows the enlarged detail J of FIG. 13;

FIG. 15 shows the enlarged detail S of FIG. 13;

FIG. 16 shows the front view of the lower portion of the frame according to this invention;

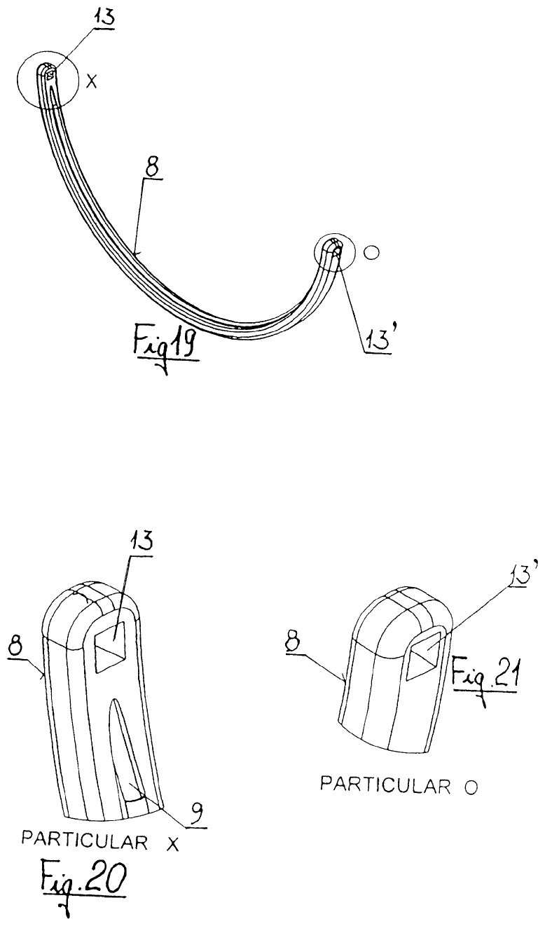

FIG. 17 shows the top view of the lower portion of the frame of FIG. 16;

FIG. 18 shows the enlarged detail C of FIG. 16;

FIG. 19 shows the perspective view of the lower portion of the frame of FIG. 16;

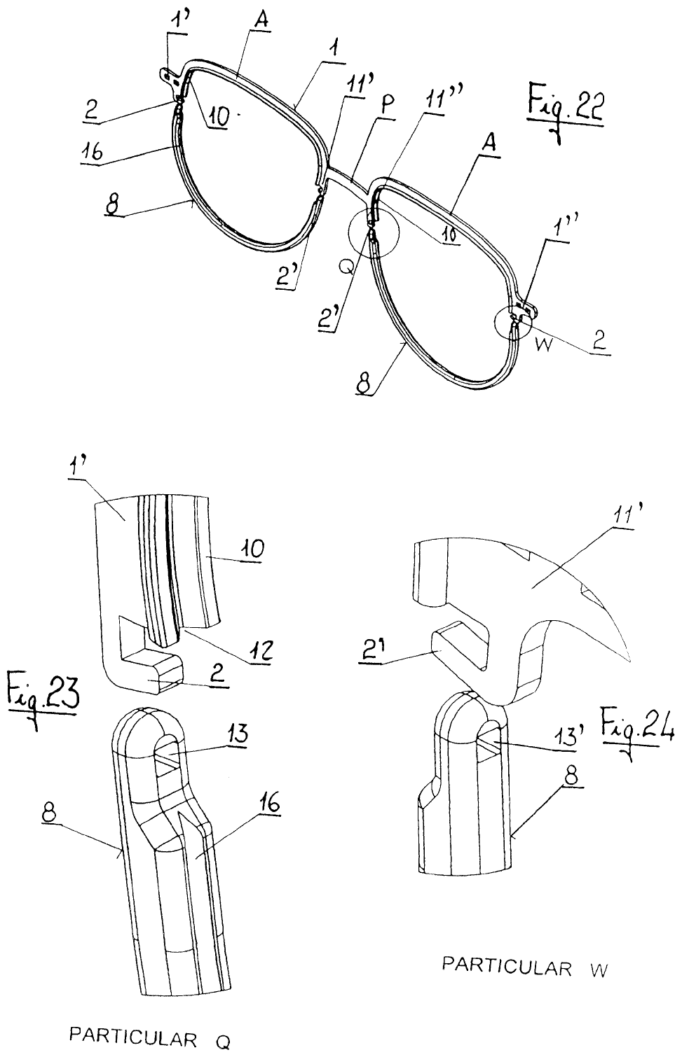

FIG. 20 shows the enlarged detail X of FIG. 19;

FIG. 21 shows the enlarged detail O of FIG. 19;

FIG. 22 shows the exploded perspective view of the frame without lenses according to this invention;

FIG. 23 shows the enlarged detail Q of FIG. 22;

FIG. 24 shows the enlarged detail W of FIG. 22;

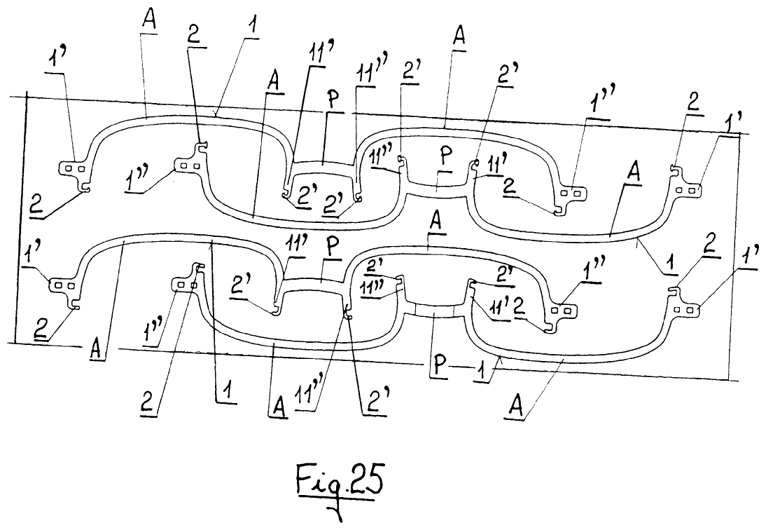

FIG. 25 shows four upper portions of the frame according to the four illustrated embodiments obtained from a single piece of plate.

With reference to the aforementioned Figures, the spectacles frame, according to this invention, is of the two-piece type and is fitted with a device of coupling of a pair of lenses to the frame itself.

This frame comprises a rigid upper portion 1, made of metallic or otherwise rigid material, for example carbon fibre, and a lower portion 8 of plastic material or, in any case, heat deformable material.

The upper portion comprises two semi-oval arches A, joined by a bridge P, suitable for covering each at least partially a lens L.

The fixing device comprises, at both ends 1′, 1″, and 11′, 11″ of said arches an appendix 2, 2′ shaped like a “C” facing towards the same lenses. Preferably, the lower end portion of said “C” shaped part is slightly tilted upward to more securely retain the lenses once mounted as shown in FIGS. 4-6.

In an additional embodiment shown in FIGS. 13-15, said appendix 2, 2′ is in the form of a “C” facing the lenses, of each eyepiece, but has a detent 3, 3′ in the lower end portion. In a further embodiment shown in FIGS. 10-12, said appendix 2, 2′ is in the shape of a “C” facing the lenses of each eyepiece, but has a double detent 15, 15′, one facing upwards, the other downwards.

In yet another embodiment illustrated in FIGS. 7-9, said appendix 2 is in the form of a “C” facing the lenses of each eyepiece, with the lower end portion substantially parallel to the upper portion 7.

In a further form of embodiment (not shown), the appendices 2 at the lateral ends 1′ and 1″ may be of different useful conformation with respect to the appendices 2′ placed at the ends 11′ and 11″ of the central area.

The lower portion 8 presents, in a first embodiment (FIGS. 16-20), in the inner central portion, the one facing the lens, an edge 9 which is to be interlocked with a specially shaped groove formed on the edge of the lens, so as to hold it, once hooked to the upper portion of the frame 1. Said upper portion of the frame also has, in the central inner portion 10 of the arches A, a similar edge which fits with the said groove on the lens to hold it in position.

In a second embodiment (FIGS. 22-24), the lower portion 8 of the frame has, in the inner central portion, a groove 16 adapted to retain the specially shaped lens therein, once hooked to the upper portion of the frame 1 Said upper portion of the frame also has, in the central inner portion 10 of the arches A, a groove 12, adapted to retain the lens.

In all the embodiments indicated, both ends of the lower portion 8 of plastic or other deformable material are fitted with a hole 13, 13′ of rectangular shape or other convenient shape (FIGS. 19, 20, 21, 23, 24) which allows the engagement of said lower portion 8 to the rigid upper portion 1 of the frame, once the lenses are inserted in the appropriate ocular spaces.

The lower portion 8, made of plastic or other deformable material, is heat-formed according to the shape of the lens to be mounted.

The assembly operation is quite simple since, after heating and locking the lens in the appropriate seat formed in the rigid upper portion 1 of the frame, it is sufficient to join the lower portion 8 by inserting the fixing appendix 2′ into the hole 13′ in a first end of the frame and, therefore, the appendix 2 in the hole 13 of the second end of the lower portion 8 of the frame to obtain a stable and secure constraint of the lens L.

In this way, assembly and disassembly operations are quite simple without the need to use screwdrivers or other tools.

The lenses, however, can be replaced not only with others of the same shape or size but also with lenses of other and different shape or size, by replacing only the lower portion with another of adequate length able to allow the attachment to the portion rigid upper 1 (FIG. 3). Therefore, the particular aesthetic requirements of the frame desired by the user are also met either by replacing the lenses with others of a different shape, as mentioned above, or by replacing only the lower portion made of plastic or other deformable material with another of different colour.

It should be noted, however, that the upper portion 1 of the frame in metallic material is obtained, for example, by using a laser cutting system and it is therefore possible to obtain two or more pieces of frame using a single sheet of metal (FIG. 25).

In this way, it is possible to achieve significant savings in production costs while minimising material waste.

The frame, according to this invention, allows a simple assembly of the components and, in particular, of the lenses which can be easily replaced by interlocking and, therefore, without the use of screws or other fixing devices.

What is claimed is:

1. A two piece spectacles frame with a pair of lenses fixed to the spectacles frame itself, the spectacles frame comprising:
a rigid upper portion,
a lower portion made of deformable material,
the upper portion and lower portion adapted to hold each lens in position by locking,
said upper portion comprising two semi-oval arches, joined by a bridge, each arch adapted to surround at least partially each lens, and
a fixing device for fixing the pair of lenses to the spectacles frame itself, said fixing device comprising:
a “C” shaped appendix on each end of said arches of the rigid upper portion facing the lenses themselves, the “C” shaped appendix having a lower end portion fitted with a detent, and
a hole at ends of the lower portion which permits the locking of said lower portion with the rigid upper portion, once the lenses have been inserted in a special ocular space of the lower portion, by inserting the appendices inside said holes.

2. A two piece spectacles frame according to claim 1, wherein the lower end portion of the “C” shaped appendix is slightly tilted upward.

3. A two piece spectacles frame according to claim 1, wherein the lower end portion of the “C” shaped appendix has a double detent, with one facing upwards and the other facing downwards.

4. A two piece spectacles frame according to claim 1, wherein the lower end portion of the “C” shaped appendix is substantially parallel to an upper portion thereof.

5. A two piece spectacles frame according to claim 1, wherein the lower portion is made of a heat deformable plastic material.

6. A two piece spectacles frame according to claim 1, wherein the arches of the rigid upper portion and the lower portion have, in internal portions thereof, and facing the lens, an edge which receives a specially shaped groove made on the edge of the lens adapted to hold the lens.

7. A two piece spectacles frame according to claim 1, wherein the arches of the rigid upper portion have, in a central internal portion thereof, a groove, and the lower portion has a groove, of adapted for holding a specially shaped lens therein.

8. A two piece spectacles frame according to claim 1, wherein the upper portion t of the frame is of a metallic material and is made by a laser cutting system.
